(19) United States
(12) Patent Application Publication
(10) Pub. No.: US 2008/0126061 A1
(43) Pub. Date: May 29, 2008

(54) ANALYSIS TECHNIQUES TO REDUCE SIMULATIONS TO CHARACTERIZE THE EFFECT OF VARIATIONS IN TRANSISTOR CIRCUITS

(76) Inventors: Jerry D. Hayes, Georgetown, TX (US); Sambasivan Narayan, Essex Junction, VT (US); Jeffery H. Oppold, Richmond, VT (US); James E. Sundquist, Colchester, VT (US)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/464,014

(22) Filed: Aug. 11, 2006

(51) Int. Cl. G06F 17/50

(52) U.S. Cl. 703/14

(57) ABSTRACT

Embodiments of the invention provide a method, computer program product, etc. for analysis techniques to reduce simulations to characterize the effect of variations in transistor circuits. A method of simulating transistors in an integrated circuit begins by reducing a group of parallel transistors to a single equivalent transistor. The equivalent transistor is subsequently simulated, wherein only a portion of the parallel transistors are simulated. Next, the integrated circuit is divided into channel-connected components and simulated for the channel-connected components. A table is created for each type of channel-connected component; and parameterized across chip variation equations are calculated from results of the integrated circuit simulation. Moreover, table entries are created, which include a number of transistor types, a number of unique transistor primitive patterns, and/or a number of paths through each of the transistor primitive patterns.

### BACKGROUND

1. Field of the Invention

Embodiments of the invention provide a method, computer program product, etc. for analysis techniques to reduce simulations to characterize the effect of variations on transistor circuits.

2. Description of the Related Art

Transistors in the latest sub-micron technologies are known to exhibit variations in their properties, which causes uncertainties in their electrical and temporal behaviors. These uncertainties must be accounted for and characterized in order to build a successful integrated circuit (IC) design. A typical circuit may consist of several transistors each of which has several properties such as length, width and threshold voltage, which can vary independently (across chip variations or ACV). The known solutions to characterize this problem are “brute-force” techniques, in which each property, in each transistor, is varied and for every unique setting, the circuit simulated to calculate the overall effect. This leads to an enormous increase in the amount of time spent in circuit simulations. This increase is further aggravated by two commonly used design techniques: the use of electrically equivalent parallel transistors (called “fingers”) to increase the amount of current drive strength and the use of multiple “types” of transistors within the same design.

### SUMMARY

Embodiments of the invention provide a method, computer program product, etc. for analysis techniques to reduce simulations to characterize the effect of variations on transistor circuits. A method of simulating transistors in an integrated circuit begins by reducing a group of parallel transistors to a single equivalent transistor. The equivalent transistor is subsequently simulated, wherein only a portion of the parallel transistors are simulated.

Next, the integrated circuit is divided into channel-connected components and simulated for the channel-connected components. A table is created for each type of channel-connected component; and, parameterized across chip variation equations are calculated from results of this simulation. Moreover, table entries are created, which include a number of transistor types, a number of unique transistor primitive patterns, and/or a number of paths through each of the transistor primitive patterns.

The method further comprises obtaining parameterized across chip variation equation(s) from the table for each unique pattern in the integrated circuit; and calculating a variance of each channel-connected component. A variance of delay for each path of the integrated circuit is also obtained by adding the variance of each channel-connected component in the path. When two paths of the integrated circuit begin at a same input and end at a same output, the method obtains the variance of delay having the largest or smallest value and/or creates a linear combination of the two paths based on the variance of delay.

Accordingly, embodiments of the invention provide a circuit reduction procedure that can be applied to the given transistor circuit before a simulation procedure, to obtain a reduced circuit consisting of lesser number of transistors and hence a lesser number of simulations to run. In addition, a method is provided to handle larger transistor circuits using a transistor pattern-based lookup table approach, which does not use any simulations to determine the ACV effect on the output.

These and other aspects of the embodiments of the invention will be better appreciated and understood when considered in conjunction with the following description and the accompanying drawings. It should be understood, however, that the following descriptions, while indicating preferred embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIGS. 1A and 1B are diagrams illustrating transistor reduction;

FIGS. 2A and 2B are diagrams illustrating another transistor reduction;

FIG. 3 is a diagram illustrating a switching transistor reduction;

FIG. 4 is a diagram illustrating a multistage switching transistor reduction;

FIG. 5 is a diagram illustrating another switching transistor reduction;

FIG. 6 is a diagram illustrating a transistor pattern;

FIG. 7 is a diagram illustrating channel-connected components;

FIG. 8 is a flow diagram illustrating a preferred method for analysis techniques to reduce simulations to characterize the effect of variations in transistor circuits; and

FIG. 9 is a diagram illustrating a computer program product.

### DETAILED DESCRIPTION OF PREFERRED EMBODIMENTS

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Thus, the examples should not be construed as limiting the scope of the embodiments of the invention.

Accordingly, embodiments of the invention provide a circuit reduction procedure that can be applied to the given transistor circuit before a simulation procedure, to obtain a reduced circuit consisting of lesser number of transistors and hence a lesser number of simulations to run. In addition, a method is provided to handle larger transistor circuits using a transistor pattern-based lookup table approach which does not use any simulations to determine the ACV effect on the output.

Embodiments herein provide a set of circuit analysis techniques to be applied to a transistor level circuit, consisting of one or more “types” of transistors to determine a small subset of simulations to be run in a simulator. Because the amount of time spent on this analysis is trivial compared to even a single circuit simulation run, there is a tremendous amount of time savings.

A feature of the variations that is being leveraged is that they have a fairly small magnitude compared to the nominal value and hence first-order assumptions are applicable and the variations fit normal (Gaussian) statistics. The runtime benefits can be contrasted with other approaches such as the Powerspice “SENSIT” function, which runs at least one simulation for every varying parameter for every varying transistor, which is a linear runtime in the number of transistors and parameters. Depending on the amount of repeating structures, the approach herein gives a result in almost constant time.

Thus, embodiments of the invention provide parameter space reduction for ACV characterizations. The purpose is to estimate the effect of independent variations of transistor parameters on output; and, to determine variable space for simulation, wherein N=the number of layout transistors, P=the number of parameters, and wherein N times P=the number of variables. Embodiments herein can reduce variable space under various assumptions. The assumptions include ACV effects on output are “first-order” and additive; interconnect/contact effects are negligible; and ACV effects on diffusion resistance, gate capacitance, and sub-threshold current are negligible.

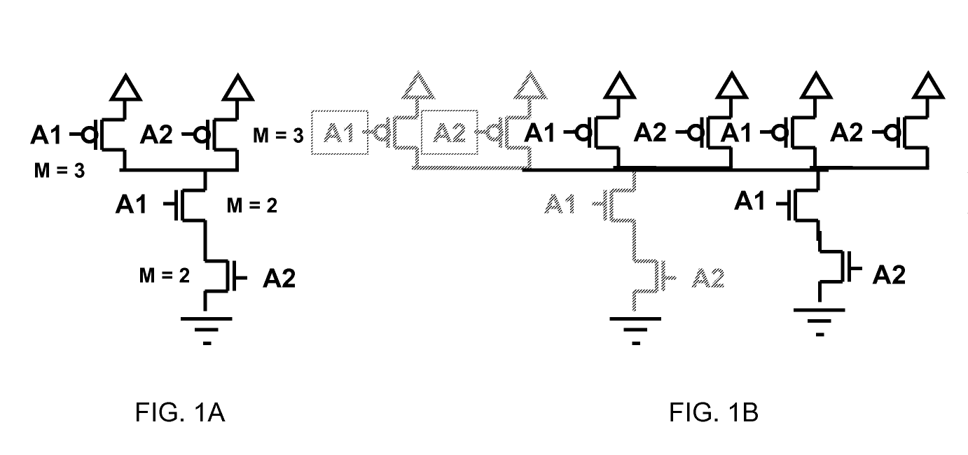

Referring to FIGS. 1A and 1B, embodiments of the invention reduce variable space by simulating only one “schematic” transistor. All the variations in parallel transistors are assumed to have “equivalent” effect. FIG. 1A illustrates a schematic having four transistors; and, FIG. 1B illustrates a layout having 10 transistors. Simulating the transistors in grey dotted lines from the layout saves 60% of simulations

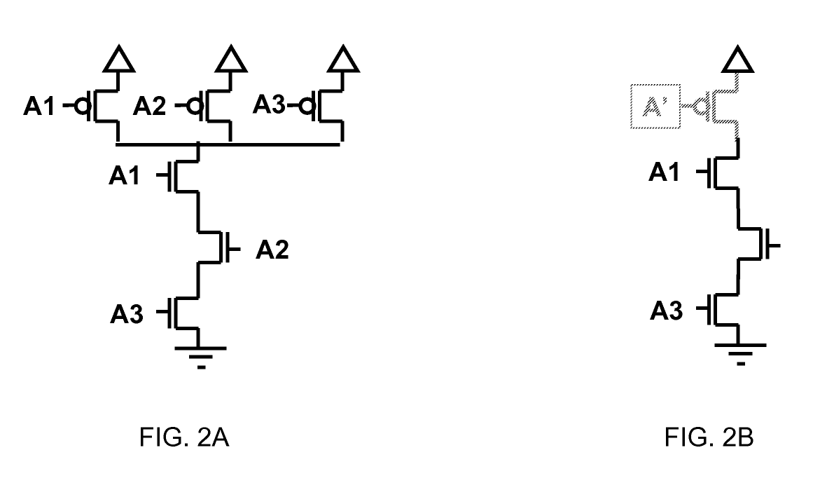

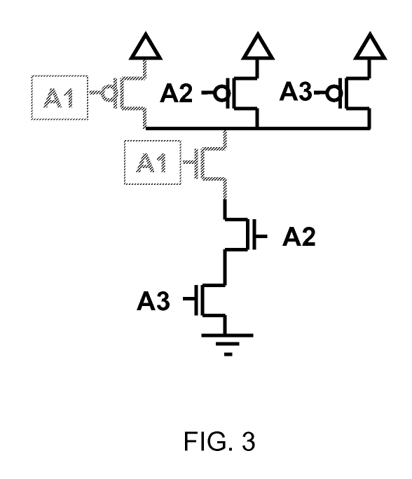

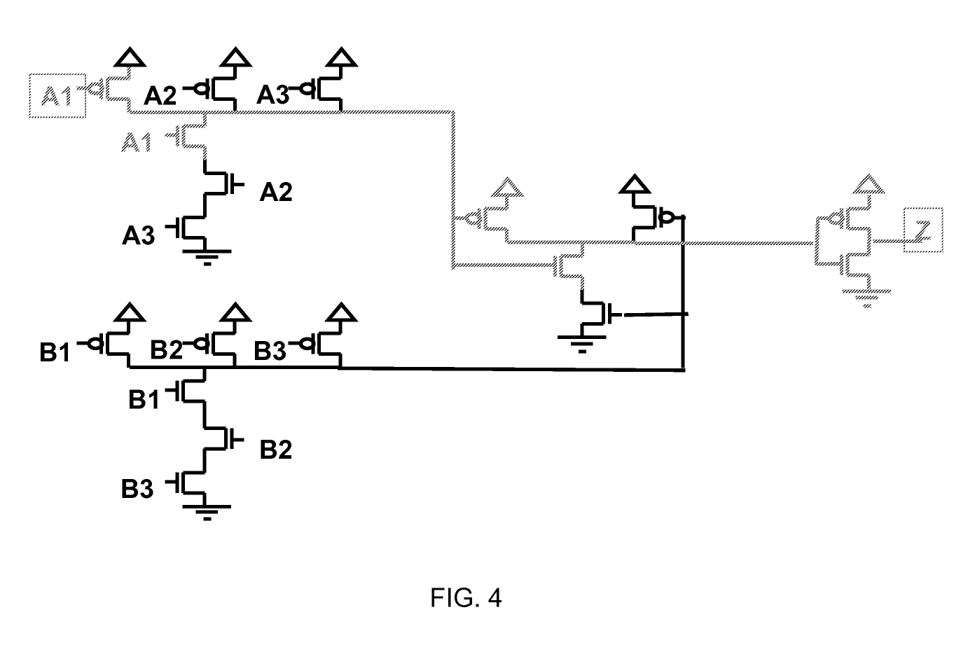

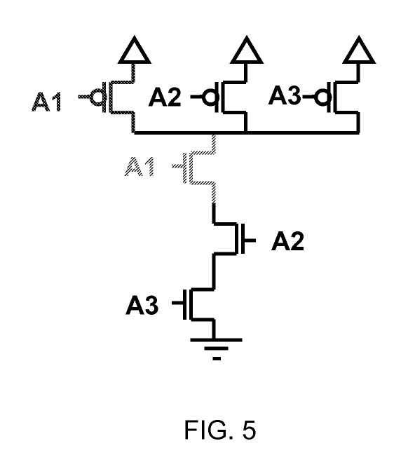

In FIGS. 2A and 2B, all parallel transistors are reduced to one equivalent transistor. ACV due to all P-type field effect transistors (PFETs) with gates A1=P times ACV due to PFET to A′. Specifically, P is the ratio of the width of the PFET tied to A1 to the PFET tied to A′. In FIG. 3, just the switching transistor (the transistor in grey) is simulated. The effects of the other transistors are ignored. For A1−Z delay arc, the effects of PFETs and n-type field effect transistors (NFETs) connected to inputs A2 and A3 are ignored. FIG. 4 illustrates a multistage example with an A1−Z delay path. In FIG. 5, another switching transistor reduction is shown, wherein the effects of the complementary transistor is also ignored. For A1 falling Z rising path, only PFET to A1 is used. For A1 rising Z falling path, only NFET to A1 is used.

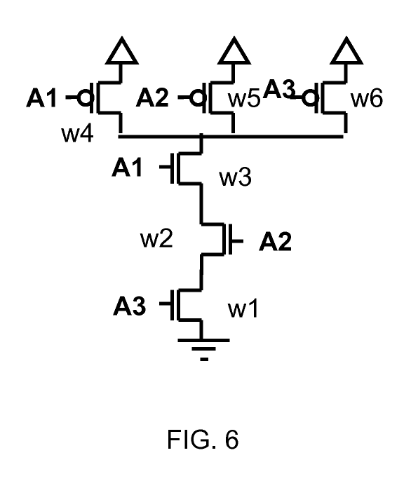

In addition, embodiments of the invention calculate ACV for large transistor circuits and avoid simulations of such circuits. This assumes that delay variations are additive along a path and follow normal (Gaussian) statistics; and that slew/load cap effects due to variation are negligible. Further, it is assumed that ACV sensitivities are constant (with respect to transistor length, width); and that there is “commonality” in transistor topologies in large circuits. A first step creates a pattern table, wherein the table “key” is the transistor pattern. The pattern could be “reduced” circuit as illustrated in FIGS. 1-5. As illustrated in FIG. 6, parameters are W1 . . . W6, the width of the devices. The “value” stored in the table is a first order equation of the form:

Var(Δtd)=Σi=1,6(αi wi)2Var(α)+(βi wi)2Var(β)

where αi, βi are the sensitivities of the α and β parameter (e.g., length & width) of the ith transistor, with respect to the output function (e.g., A1 to Z delay) calculated with the FETs width set to some unit value.

Each “type” (like different threshold voltages or different gate oxide thickness) of transistor in technology adds one extra dimension to the pattern table. In regards to table entries having linear memory complexity, T=the number of types of transistors; N=the number of unique transistor primitive patterns; and, P=the number of paths through each transistor primitive. The number of entries=T times N times P.

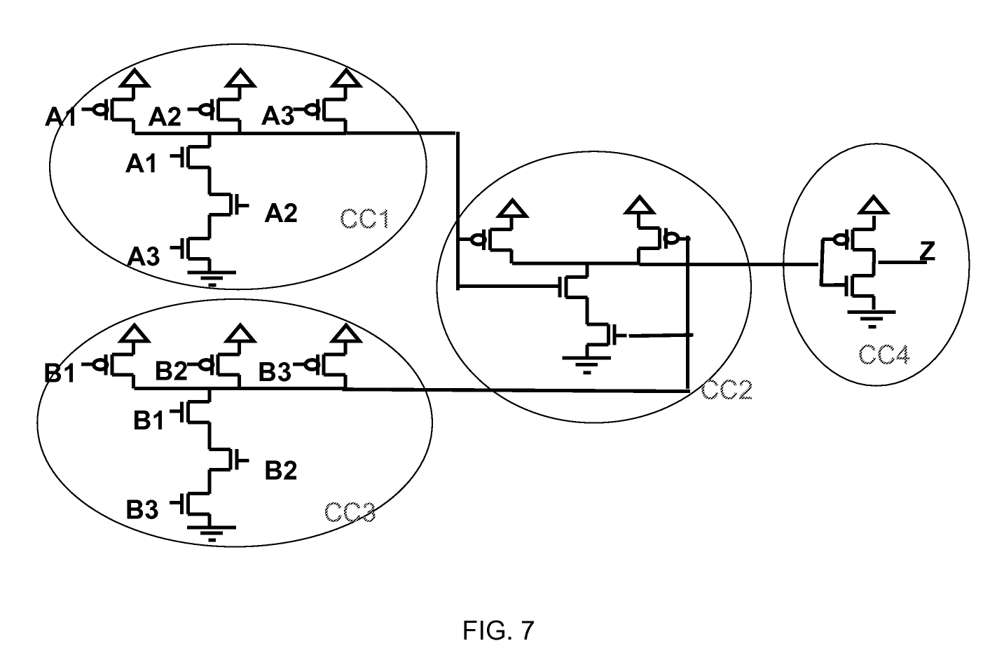

The next step is to divide the circuit into channel-connected components (also referred to herein as CCCs) using standard definition of channel-connected components and standard techniques. For example, FIG. 7 illustrates four channel-connected components (i.e., CC1, CC2, CC3, and CC4) and three unique patterns. More specifically, the four channel-connected components include two “NAND3” patterns; one “NAND2” pattern; and, one “INVERT” pattern. Furthermore, only those “types” of transistors in path are used. In the example, A−Z delay is independent of types of transistors used in CC3.

The following step obtains a parameterized ACV equation from a lookup table, for each unique pattern, and calculates the variance for each channel-connected component. Next, the path variance is obtained. Specifically, for each path, the variance of delay is obtained through path by adding the variance of each channel-connected component in the path. Thus, for the example illustrated in FIG. 7, Var(Delay from A1−Z)=Var(CC1) +Var(CC2)+Var(CC4).

In creating the lookup table, the simple static complementary metal oxide semiconductor (CMOS) single stage topologies can be obtained from the ACV calculations for the primitive libraries. To handle general custom designs, patterns may be needed, with each of the static CMOS structures driving a pass gate structure at the output. If a pattern is unique to a design, then it needs to be “calibrated” and an entry created for it, or it can be handled “on-the-fly”.

Moreover, in regards to the first-order assumption, the sensitivities are (αp, βp, αn, and βn. These are usually functions of the width/length of the transistor, which is assumed as constant. Fixes include calculating sensitivities for more than one width and obtaining the “best-fit” constant value; stamping a “width” dependent equation; and increasing the number of calibration simulations.

For handling two paths re-converging at an output (from the same input), a conservative approach uses the largest path variance. Other approaches include linear combination based on delay, and an EinsStat-like ratio/tightness approach.

Thus, embodiments of the invention provide a method, computer program product, etc. for analysis techniques to reduce simulations to characterize the effect of variations in transistor circuits. A method of simulating transistors in an integrated circuit begins by reducing a group of parallel transistors to a single equivalent transistor. As described above, this assumes that ACV effects on output are “first-order” and additive; interconnect/contact effects are negligible; and ACV effects on diffusion resistance, gate capacitance, and sub-threshold current are negligible. The equivalent transistor is subsequently simulated, wherein only a portion of the parallel transistors are simulated. As described above, parallel transistors are assumed to have “equivalent” effect.

Next, the integrated circuit is divided into channel-connected components and simulated for the channel-connected components. As illustrated in FIG. 7, only those “types” of transistors in path are used, wherein A1−Z delay is independent of types of transistors used in CC3. A table is created for each type of channel-connected component; and, parameterized across chip variation equations are calculated from results of the integrated circuit simulation. As described above, methods herein assume that delay variations are additive along a path and follow normal (Gaussian) statistics; and slew/load cap effects due to variation are negligible. Further, it is assumed that ACV sensitivities are constant (with respect to transistor length, width); and that there is “commonality” in transistor topologies in large circuits. Table entries are created, which include a number of transistor types, a number of unique transistor primitive patterns, and/or a number of paths through each of the transistor primitive patterns. As described above, the number of entries=T£N£P.

The method further comprises obtaining parameterized across chip variation equation(s) from the table for each unique pattern in the integrated circuit; and calculating a variance of each channel-connected component. A variance of delay for each path of the integrated circuit is also obtained by adding the variance of each channel-connected component in the path. Thus, for the example illustrated in FIG. 7, Var(Delay from A1−Z) =Var(CC1)+Var(CC2)+Var(CC4). When two paths of the integrated circuit begin at a same input and end at a same output, the method obtains the variance of delay having the largest value and/or creates a linear combination of the two paths based on the variance of delay. As described above, other approaches include linear combination based on delay, and an EinsStat-like ratio/tightness approach.

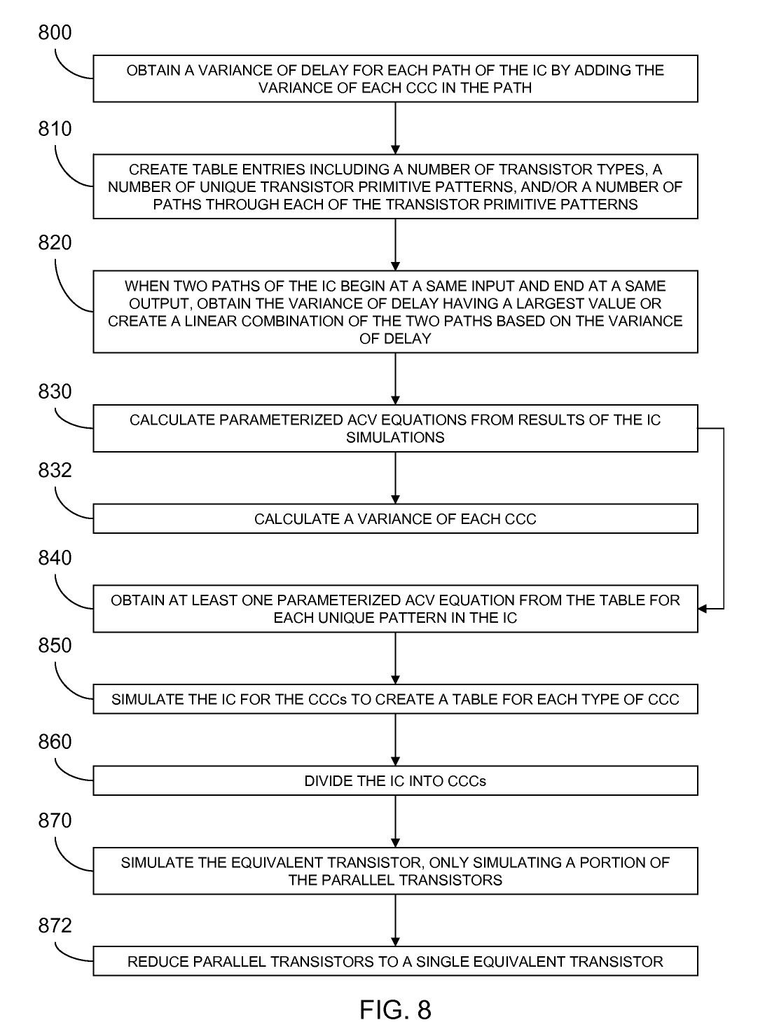

FIG. 8 illustrates a flow diagram for a method of simulating transistors in an integrated circuit. The method begins in item 800 by reducing a plurality of parallel transistors to a single equivalent transistor. As described above, this assumes that ACV effects on output are “first-order” and additive; interconnect/contact effects are negligible; and ACV effects on diffusion resistance, gate capacitance, and sub-threshold current are negligible. Next, in item 810, the method simulates the equivalent transistor, which only simulates a portion of the parallel transistors. As described above, because the amount of time spent on this analysis is trivial compared to even a single circuit simulation run, there is a tremendous amount of time savings.

Following this, in item 820, the integrated circuit is divided into channel-connected components. The example in FIG. 7 illustrates four channel-connected components including two “NAND3” patterns; one “NAND2” pattern; and, one “INVERT” pattern. Subsequently, in item 830, the integrated circuit is simulated for the channel-connected components to create a table for each type of the channel-connected components. As described above, the table “key” is the transistor pattern. In item 834, table entries are created including a number of transistor types, a number of unique transistor primitive patterns, and/or a number of paths through each of the transistor primitive patterns. As described above, each type of transistor in technology adds one extra dimension to the pattern table. Further, in item 840, parameterized across chip variation equations are calculated from results of the simulating of the integrated circuit.

Next, in item 850, the method obtains parameterized across chip variation equation(s) from the table for each unique pattern in the integrated circuit; and, in item 860, a variance of each the channel-connected components is calculated. Following this, in item 870, a variance of delay for each path of the integrated circuit is obtained by adding the variance of each the channel-connected components in the path. Thus, for the example illustrated in FIG. 7, Var(Delay from A1−Z)=Var(CC1)+Var(CC2)+Var(CC4). When two paths of the integrated circuit begin at a same input and end at a same output, the method, in item 872, obtains the variance of delay comprising a largest value or creates a linear combination of the two paths based on the variance of delay. As described above, other approaches include linear combination based on delay, and an EinsStat-like ratio/tightness approach.

The embodiments of the invention can take the form of an entirely hardware embodiment, an entirely software embodiment or an embodiment including both hardware and software elements. In a preferred embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

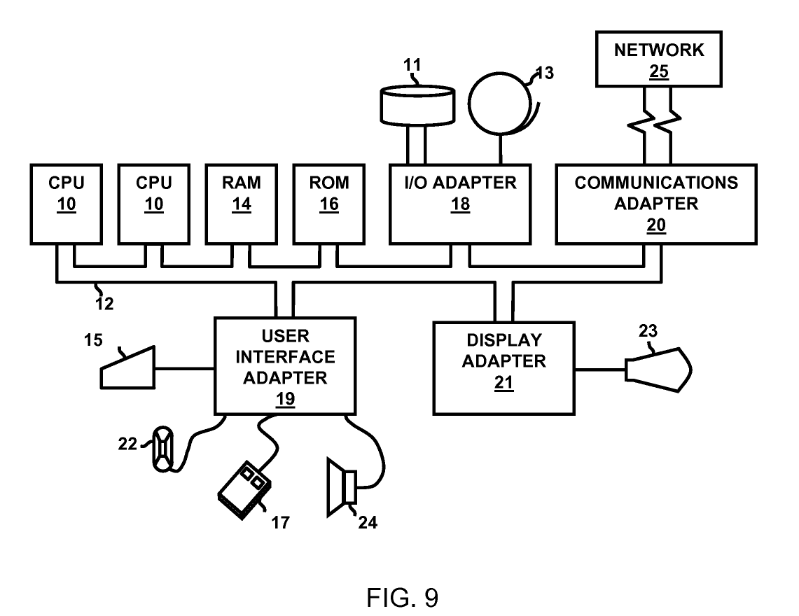

A representative hardware environment for practicing the embodiments of the invention is depicted in FIG. 9. This schematic drawing illustrates a hardware configuration of an information handling/computer system in accordance with the embodiments of the invention. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

Accordingly, embodiments of the invention provide a circuit reduction procedure that can be applied to the given transistor circuit before a simulation procedure, to obtain a reduced circuit consisting of lesser number of transistors and hence a lesser number of simulations to run. In addition, a method is provided to handle larger transistor circuits using a transistor pattern-based lookup table approach, that does not use any simulations to determine the ACV effect on the output.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of preferred embodiments, those skilled in the art will recognize that the embodiments of the invention can be practiced with modification within the spirit and scope of the appended claims.

What is claimed is:

1. A method of simulating transistors in an integrated circuit, comprising:
reducing a plurality of parallel transistors to a single equivalent transistor;
simulating said equivalent transistor;
dividing said integrated circuit into channel-connected components; and
simulating said integrated circuit for said channel-connected components to create a table for each type of said channel-connected components.

2. The method according to claim 1, wherein said simulating of said equivalent transistor only simulates a portion of said parallel transistors.

3. The method according to claim 1, wherein said simulating of said integrated circuit comprises creating table entries comprising at least one of a number of transistor types, a number of unique transistor primitive patterns, and a number of paths through each of said transistor primitive patterns.

4. The method according to claim 1, further comprising:
obtaining a parameterized across chip variation equation from said table for each unique pattern in said integrated circuit; and
calculating a variance of each said channel-connected components.

5. The method according to claim 4, further comprising obtaining a variance of delay for each path of said integrated circuit.

6. The method according to claim 5, wherein said obtaining of said variance of delay comprises adding said variance of each said channel-connected components in said path.

7. The method according to claim 5, further comprising, when two paths of said integrated circuit begin at a same input and end at a same output, performing one of:
obtaining said variance of delay comprising a largest value; and
creating a linear combination of said two paths based on said variance of delay.

8. A method of simulating transistors in an integrated circuit, comprising:
reducing a plurality of parallel transistors to a single equivalent transistor;
simulating said equivalent transistor;
dividing said integrated circuit into channel-connected components;
simulating said integrated circuit for said channel-connected components to create a table for each type of said channel-connected components; and
calculating parameterized across chip variation equations from results of said simulating of said integrated circuit.

9. The method according to claim 8, wherein said simulating of said equivalent transistor only simulates a portion of said parallel transistors.

10. The method according to claim 8, wherein said simulating of said integrated circuit comprises creating table entries comprising at least one of a number of transistor types, a number of unique transistor primitive patterns, and a number of paths through each of said transistor primitive patterns.

11. The method according to claim 8, further comprising:
obtaining at least one of said parameterized across chip variation equations from said table for each unique pattern in said integrated circuit; and
calculating a variance of each said channel-connected components.

12. The method according to claim 11, further comprising obtaining a variance of delay for each path of said integrated circuit.

13. The method according to claim 12, wherein said obtaining of said variance of delay comprises adding said variance of each said channel-connected components in said path.

14. The method according to claim 12, further comprising, when two paths of said integrated circuit begin at a same input and end at a same output, performing one of:
obtaining said variance of delay comprising a largest value; and
creating a linear combination of said two paths based on said variance of delay.

15. A method of simulating transistors in an integrated circuit, comprising:
reducing a plurality of parallel transistors to a single equivalent transistor;
simulating said equivalent transistor;
dividing said integrated circuit into channel-connected components;
simulating said integrated circuit for said channel-connected components to create a table for each type of said channel-connected components;
calculating parameterized across chip variation equations from results of said simulating of said integrated circuit;
obtaining at least one of said parameterized across chip variation equations from said table for each unique pattern in said integrated circuit;
calculating a variance of each said channel-connected components; and
obtaining a variance of delay for each path of said integrated circuit.

16. The method according to claim 15, wherein said simulating of said equivalent transistor only simulates a portion of said parallel transistors.

17. The method according to claim 15, wherein said simulating of said integrated circuit comprises creating table entries comprising at least one of a number of transistor types, a number of unique transistor primitive patterns, and a number of paths through each of said transistor primitive patterns.

18. The method according to claim 15, wherein said obtaining of said variance of delay comprises adding said variance of each said channel-connected components in said path.

19. The method according to claim 15, further comprising, when two paths of said integrated circuit begin at a same input and end at a same output, performing one of:
obtaining said variance of delay comprising a largest value; and
creating a linear combination of said two paths based on said variance of delay.

20. A computer program product comprising a computer usable medium tangibly embodying a computer readable program, wherein the computer readable program, when executed on a computer, causes the computer to perform a method comprising:
reducing a plurality of parallel transistors to a single equivalent transistor;
simulating said equivalent transistor;
dividing said integrated circuit into channel-connected components; and
simulating said integrated circuit for said channel-connected components to create a table for each type of said channel-connected components.
